(19) United States
(12) Patent Application Publication
(10) Pub. No.: US 2018/0271060 A1
(43) Pub. Date: Sep. 27, 2018

(54) PET SCRATCHING DEVICE AND METHOD

(71) Applicant: Kyle Raymond Hansen, Castle Rock, CO (US)

(72) Inventor: Kyle Raymond Hansen, Castle Rock, CO (US)

(21) Appl. No.: 15/469,420

(22) Filed: Mar. 24, 2017

(51) Int. Cl. A01K 15/02; A01K 13/00

(52) U.S. Cl. CPC A01K 15/024; A01K 13/004

(57) ABSTRACT

The invention is a novel pet scratching device, particularly for cats, wherein a proprietary catnip formula is applied to corrugated cardboard inserts in the pieces of the device. Multiple pieces can be connected to one another like a jigsaw puzzle, and the pieces can contain varying shapes of corrugated inserts, as well as scratching or grooming accessories affixed thereto.

### FIELD

The invention relates to a novel pet scratching device, particularly for cats, wherein a proprietary catnip formula is applied to corrugated cardboard inserts in the pieces of the device. Multiple pieces can be connected to one another much like a puzzle piece, and cats can scratch corrugated surfaces to sharpen their claws, or interact with the pieces based on their shape or accessories affixed to the pieces such as a grooming brush or scratching pole.

### BACKGROUND OF THE INVENTION

The invention most closely corresponds with USPTO Class 119/174 wherein Class 119 relates to animal husbandry and sub-class 706 includes climbing or claw scratching devices.

In its simplest form, the invention relates to a novel multi-piece pet claw scratching device wherein a proprietary catnip formula is sprayed on corrugated cardboard inserts located within the toy piece frames that create a variety of activities from indentations for treats, attached scratching poles, or to bristle grooming devices.

The novel claw scratching device is also for amusement or play wherein interlocking pieces can contain a track in the corrugated insert where an inserted ball can be spun around the track by a pet.

### THE INVENTION

### Summary, Objects and Advantages

Scratching is a normal part of cat behavior and serves several functions, including conditioning of the claws, providing a means of stretching, and acting as a marker (olfactory, scent, and visual). One thing that pet owners—especially cat owners—know, is that cats will scratch. If they are not provided acceptable items to scratch, an owner's furniture or carpet are typically the first casualties of that instinct. Many cats scratch the couch because they simply do not have another option to exercise their scratching needs. All cats have a need to scratch and should be provided with appropriate items to scratch.

It is considered cruel to declaw a cat, and in many states, illegal. The optimal choice is to provide cats with items that are appropriate for them to scratch, and combine play so that there is even a greater attraction toward that scratching device.

The inventive scratching device combines interlocking pieces that have a proprietary catnip formula which is sprayed on corrugated piece inserts. The pieces can vary in terms of designs for amusement. One piece can have a track within the piece for a ball to be inserted in the track. Another piece can have indentations in the piece for treats to be placed. Another piece can have an arched bristle attachment wherein the cat may also groom and scratch itself. Another piece can have a vertical scratching post attached. The embodiments are obviously not all the options for what can be integrated into a piece, but are some of the preferred embodiments herein.

To make the pieces, a catnip solution is sprayed onto corrugated cardboard, which will then be let to dry. The dried pieces are now coated with the catnip solution in such a manner that the catnip will not easily fall or flake off the cardboard. This is an improved method that also serves to maintain the scent attraction. Most of the prior art toys require the user to sprinkle catnip into a corrugated cardboard item. That is a messy and short-lived solution.

### BRIEF DESCRIPTION OF THE DRAWINGS

The invention is described in further detail by reference to nine (9) drawings sufficient in detail to describe the invention in which:

FIG. 1 is an interlocking piece with corrugated cardboard insert;

FIG. 2 is an interlocking piece with a ball in track;

FIG. 3 is an interlocking piece with a waved corrugated cardboard insert;

FIG. 4 is an interlocking piece with indentations for food kibble;

FIG. 5 is a perspective of four interlocking pieces as connected;

FIG. 6 is an attachable bristle groomer;

FIG. 7 is an attachable scratching post;

FIG. 8 is a perspective of the interlocking pieces with the groomer attached; and

FIG. 9 is a flow chart for the catnip coating process.

### DETAILED DESCRIPTION, INCLUDING BEST MODES OF CARRYING OUT THE INVENTION

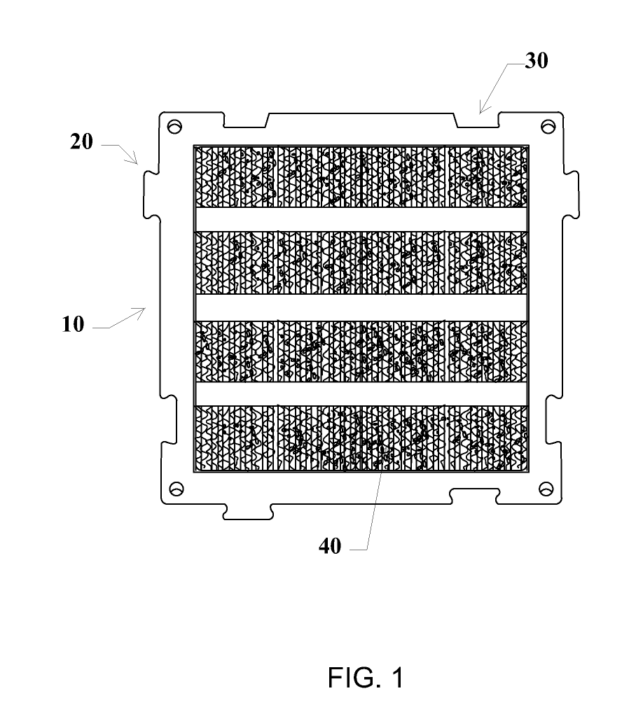

FIG. 1 is one interlocking piece of the claw scratching device. The frame of the piece 10 is plastic and contains male extrusions 20 for connecting to female intrusions 30 located on this, and other device pieces intended to receive a connecting piece. In this Fig, the catnip formula coated corrugated cardboard inserts 40 are alternating strips of cardboard and plastic nested into the frame 10.

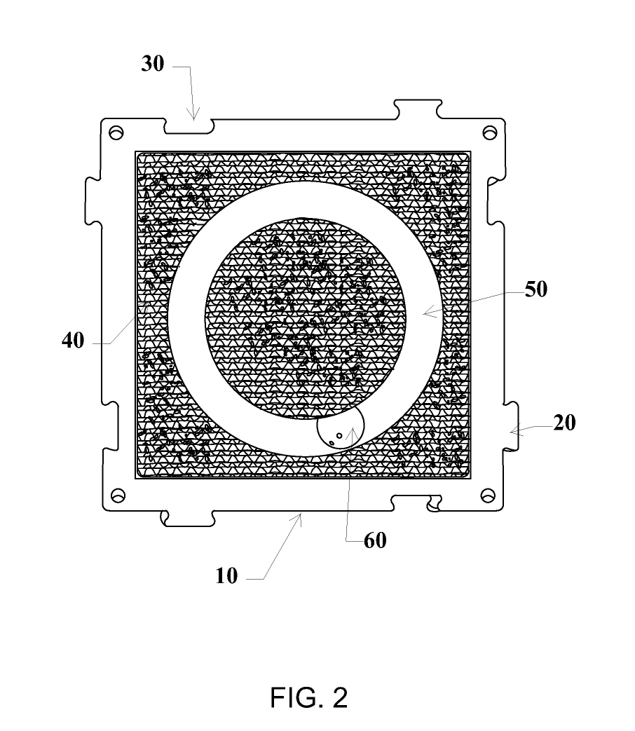

FIG. 2 is one interlocking piece of the claw scratching device. The frame 10 is plastic and contains male extrusions 20 and female intrusions 30 for connecting to other device pieces. On this piece, the catnip formula coated cardboard 40 has a track groove 50 wherein a ball 60 will rotate around the track when manipulated by a pet.

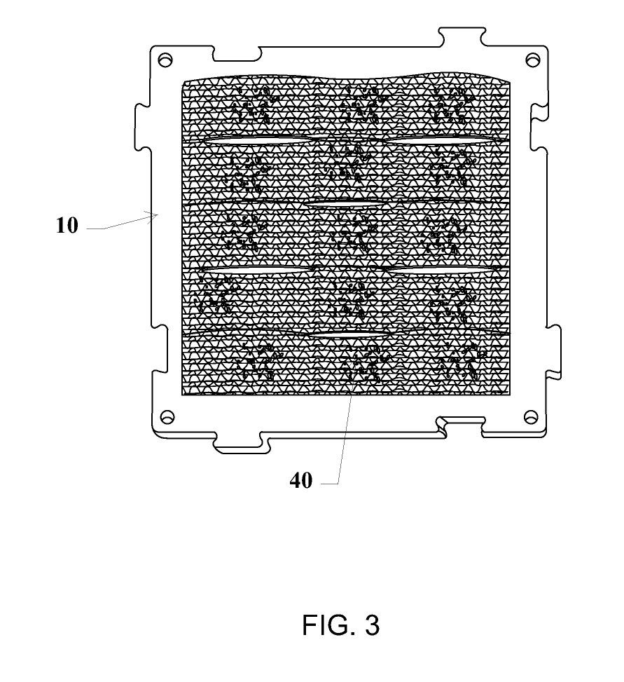

FIG. 3 is one interlocking piece of the claw scratching device. The frame 10 is plastic, and in this Figure the catnip formula coated cardboard 40 is a wave design of alternating rises and undulations, and is nested into the frame 10.

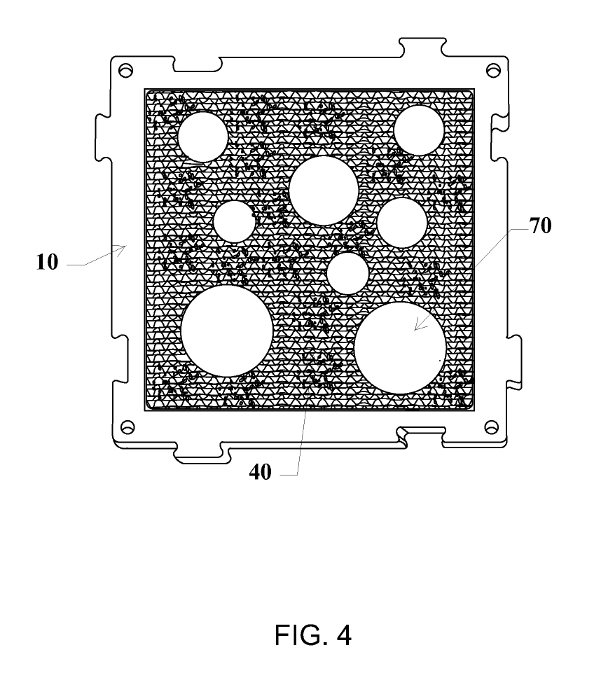

FIG. 4 is one interlocking piece of the claw scratching device. The frame 10 is plastic, and in this Figure the catnip formula coated cardboard 40 has indentations 70 wherein pet treats can be placed.

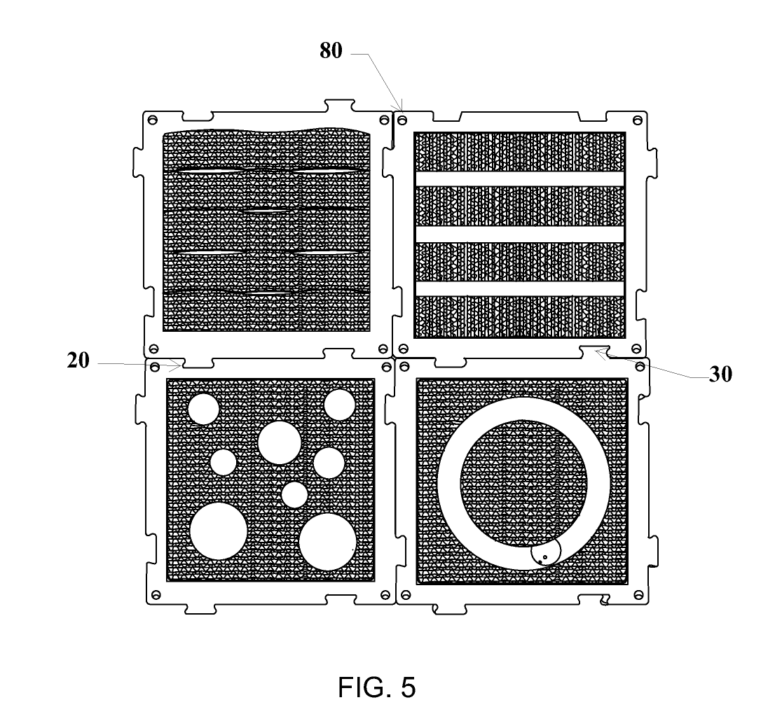

FIG. 5 is a top perspective of the pieces of the claw scratching device pieces as interlocked by the male 20 and female 30 connectors. Holes 80 on the corners of the pieces are intended for insertion of a grooming device or a vertical scratching post.

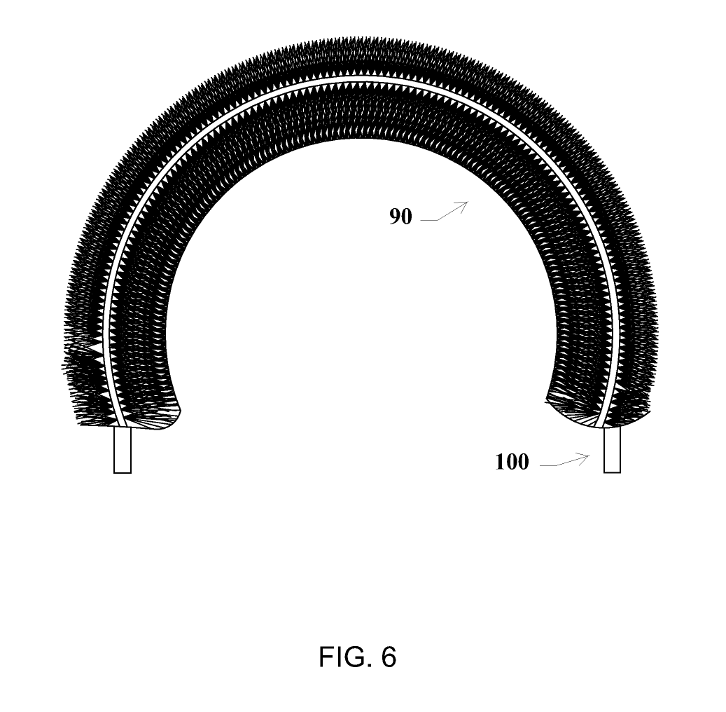

FIG. 6 is a bristled grooming device 90 that is shaped in an arch, and has stems 100 which will insert into a device piece in the frame holes provided (80 not shown in this Fig) so that a cat can rub against the bristles and groom itself as well as scratch its sides or back.

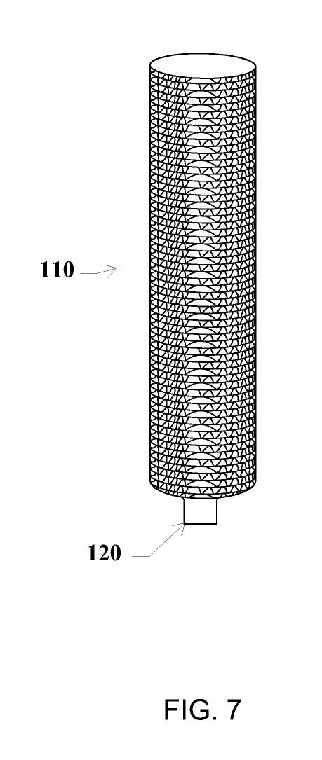

FIG. 7 is a vertical sisal wrapped scratching post 110. At the base of the post, a 120 is intended to insert into a hole on the corner of any device piece (80 not shown in this Fig). This vertical scratching post allows a cat to extend its body and scratch with a reasonable amount of force.

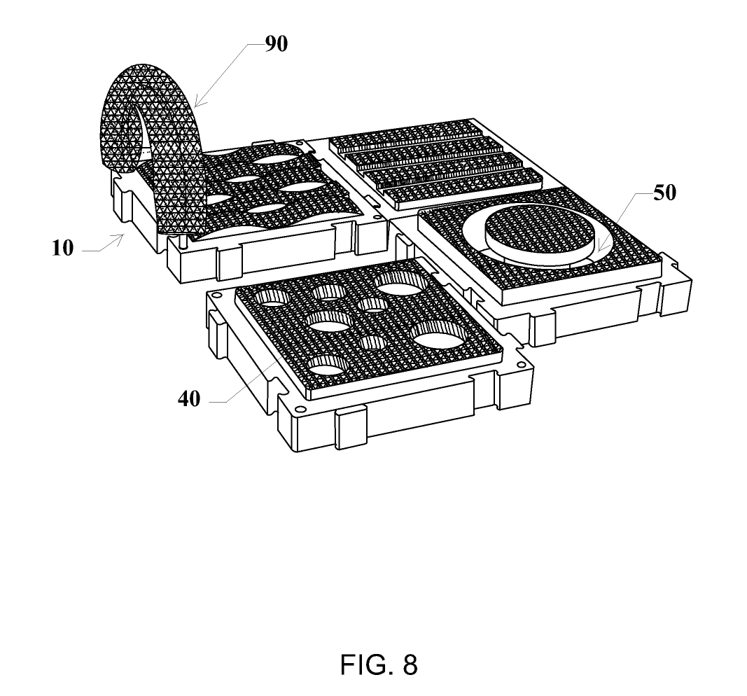

FIG. 8 is an angled perspective showing the device pieces connected. The frame 10 is plastic and contains the mal/female connectors. On this Fig, the arched bristle grooming device 90 as connected to a device piece. The catnip formula coated cardboard 40 is shown in various configurations, including the track piece 50, the piece with indentations for cat treats 70, and the wave design piece.

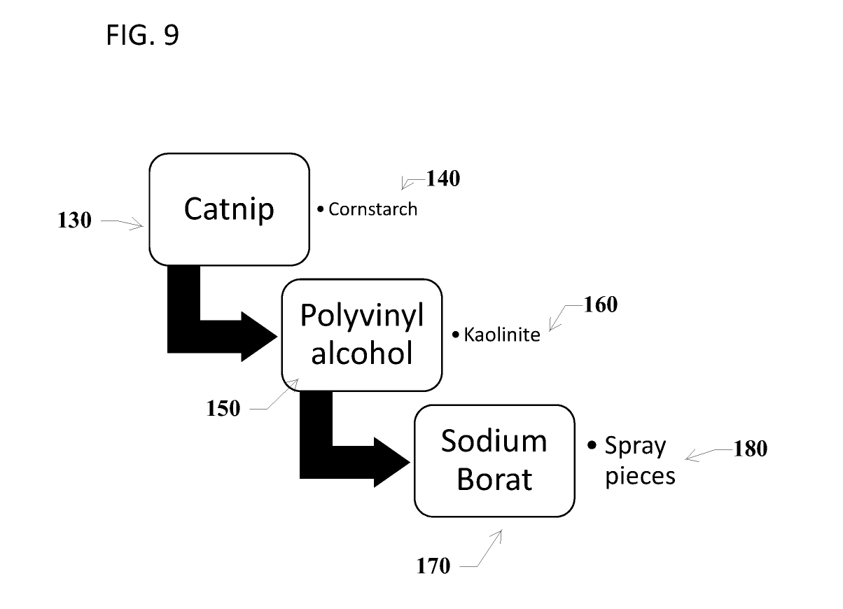

FIG. 9 is a flow chart showing the ingredients and process of creating the catnip formula for spraying onto the corrugated cardboard. The formula can be made in varying amounts as a user desires and production allows. The mixture can be made in quarts or in gallons. In the process of making the coated cardboard, a first amount of catnip 130 is placed in a sprayer which can spray the mixture. An effective amount of cornstarch 140 is mixed into the sprayer. In this Application, the Applicant defines an effective amount as that which would be known by those skilled in the art to be of a viscosity which would pass through a hand sprayer. An effective amount of polyvinyl alcohol 150 is mixed into the sprayer. An effective amount of kaolinite 160 is mixed into the sprayer. An effective amount of sodium borat 170 is mixed into the sprayer. The mixture is agitated slightly to blend the ingredients, and then sprayed 180 onto the corrugated cardboard which is then cut and shaped to any of the forms as disclosed herein and inserted into the plastic frame pieces.

1) A catnip formula coated pet claw scratching device comprising:
a) Plastic frame pieces with indentations for holding coated cardboard shapes;
b) A hole in each corner of the frame pieces for accepting accessories;
c) Male extrusions on the frame for connecting pieces;
d) Female intrusions on the frame for connecting pieces; and
e) Accessories including grooming and scratching devise.

2) The catnip formula coated pet claw scratching device as in claim 1 wherein the plastic frames indentations can accept varying cardboard pieces.

3) The catnip formula coated pet claw scratching device as in claim 1 wherein each frame piece has a hole in each corner of the piece for accepting accessories that are intended to connect to the device pieces.

3) The catnip formula coated pet claw scratching device as in claim 1 wherein each plastic frame piece has a male extrusion for connecting to a female intrusion, both of which are located alternately around the edges of each device piece.

4) The catnip formula coated pet claw scratching device as in claim 1 wherein each plastic frame piece has a female intrusion for connecting to a male extrusion, both of which are located alternately around the edges of each device piece.

5) The catnip formula coated pet claw scratching device as in claim 1 wherein an accessory is an arched bristle brush that connects via a pin at each of two ends of the bristle brush into the holes on each of a corner of frame piece.

6) A catnip formula coated pet claw scratching device as in claim 1 wherein an accessory is a vertical scratching post encircled by sisal rope, and which connects via a pin in the bottom of the post into a hole located on any corner of the device pieces.

7) A method of making a catnip coated claw scratching device wherein an effective amount of catnip is blended with appropriate amounts of corn starch, polyvinyl alcohol, kaolinite, and sodium borat to make the solution's viscosity such that it can pass through a sprayer; be slightly agitated, and finally sprayed onto pieces of corrugated cardboard which will be shaped to fit into plastic frame insert of the device pieces.
